(19) United States
(12) Patent Application Publication
(10) Pub. No.: US 2005/0209841 A1
(43) Pub. Date: Sep. 22, 2005

(54) Optimization of process properties for workflows with failing activities

(76) Inventors: Andreas Arning, Tuebingen (DE); Matthias Kloppmann, Sindelfingen (DE); Frank Leymann, Aidlingen (DE); Gerhard Pfau, Holzgerlingen (DE); Dieter Roller, Schoenaich (DE); Andreas Schmitz, Tuebingen (DE); Friedemann Schwenkreis, Leinfelden-Echterdingen (DE); Claudia Zentner, Stuttgart (DE)

Correspondence Address: IBM CORPORATION;INTELLECTUAL PROPERTY LAW, 11400 BURNET ROAD, AUSTIN, TX, 78758, US

(21) Appl. No.: 11/077,284

(22) Filed: Mar. 10, 2005

(30) Foreign Application Priority Data
Mar. 22, 2004 (DE) 04101174.3

(51) Int. Cl. G06F 9/45

(52) U.S. Cl. 703/22

(57) ABSTRACT

The present invention provides a method, a data processing system as well as a computer program product for optimizing process properties for workflows with failing activities. The invention makes use of monitoring occurrence of failure of each activity of a process model of a workflow and further monitoring properties that are associated to compensating activities that are required in order to repair the failure of an activity. The method makes explicit use of determining alternative execution sequences and selecting one of the plurality of alternative execution sequences of the process model, that optimizes the process property in case of failure of an activity of the process model. The process model itself remains unaffected and need not to be remodeled.

### FIELD OF THE INVENTION

The present invention relates to the field of failure management within workflow management systems (WFMS).

### BACKGROUND AND PRIOR ART

Workflow management systems (WFMS) support the modeling and execution of business processes. Business processes specify which piece of work of a network of pieces of work is carried out in which sequence and which resources are exploited to carry out this work pieces. Individual pieces of work might be distributed across a multitude of different computer systems connected by some type of network.

A powerful and sophisticated workflow management system, such as the product “IBM MQSeries Workflow” supports the modeling of business processes as a network of activities. This network of activities, the process model, is constructed using a directed, acyclic, weighted, colored graph as a meta model. The nodes of the graph represent the activities, which define the individual tasks that need to be carried out. Any other meta model, such as a hierarchical meta model, can be used for constructing process models without departing from the spirit of the patent application. In general, each of the activities is associated with a piece of code that implements the appropriate task. The edges of the graph, the control links, describe a potential sequence of execution of the activities. Control links are represented as arrows; the head of the arrow describes the direction in which the flow of control is moving through the process.

The activity where the control link starts is called the source activity and the activity where the control link ends is called the target activity. Obviously an activity can be source and target activity for different control links. Activities that have no incoming control link are called start activities, as they start the process. Activities which have no outgoing control link are called end activities, as after their completion the process has ended. Obviously an activity can be start activity as well as end activity. An activity that has multiple outgoing control links is called a fork activity; an activity with multiple control links a join activity.

Other meta models may offer different ways of modeling parallelism; for example by providing the notion of a set of activities. The members of the set are then carried out in parallel. It should be further noted that those constructs can be easily transformed in an appropriate representation using activities and control links.

Each of the control links of a process model is associated with a transition condition. The transition condition is stated as a Boolean expression that typically uses data that is part of the business process. The transition condition is evaluated after the source activity has completed. When the transition condition evaluates to true for a particular control link, navigation follows this control link to the appropriate target activity. If the transition condition evaluates to false, the control link is not followed. For detailed information on workflow management systems refer to “Production Workflow Concepts and Techniques” by Frank Leymann and Dieter Roller, Prentice Hall PTR.

The sequence in which the workflow management system carries out the different activities is constrained by their dependencies on other activities which are expressed by the control links. The sequence in which the different activities are carried out for a particular business process is called the execution sequence. In the case of activities that are carried out in parallel, the workflow management system has some freedom in the sequence in which the individual activities are actually carried out; thus if the process model contains parallel activities, a process may have several different execution sequences. For example, if two activities B and C are carried out in parallel, the workflow management unilaterally decides the sequence in which B and C are to be carried out; that means B before C or C before B or B and C in parallel.

If an activity fails to execute for whatever reason, certain actions are being taken dependent on appropriate specifications defined by the process modeler.

The typical reaction, if nothing particular has been specified, the process is terminated without any further actions. In this case, the workflow management system just stops processing of the currently running activities and if completed, stops any further processing. In this case, it is up to the user to perform the appropriate cleanup of the mess that has been left by the process.

In many situations however it is possible to recover from the failure of activities. A typical action is to undo the effects of related activities and then possibly continue processing generally using a different path through the business process.

A typical way of defining related activities is by enclosing them into a scope and assigning a transaction type to the scope. The transaction type specifies how the transactions whose boundaries are specified via the scope are being handled. Two distinct flavors of transaction types are prominent in the workflow management system space. The first type is the atomic type where the scope is treated as a classic ACID transaction. That means if an error occurs within the scope, the activities in the scope are undone. The second type is the compensation type where the rollback of the transaction is done by conceptually reversing the executed graph and invoking for all or selected activities compensation activities. These compensation activities undo the effects of the associated activity.

A typical example of such a scope is used in a travel reservation process, where both, the reservation of a car and the reservation of a flight are done in parallel and need to be successful. If one the activities does not complete successfully, the other activity needs to be undone. If, for example, booking of the flight does not succeed, then, if successful, the booking of the car needs to be undone. After the effects of all successfully completed activities have been undone, the process can continue, for example, by selecting the train as a means for transportation, or by informing the travel requestor about the problem and terminating the process.

The processing of the different activities has impact on the characteristics of the workflow, that means on the properties of the process. A typical property of the process are costs generated by the execution of the activities. Thus, the processing of the different activities generates certain costs that not only depend on the costs incurred by the appropriate activity implementation but also on the costs that the workflow management system generates when, for example, navigating through the process graph and invoking the activity implementations. Undoing the effects of completed activities not only creates additional costs needed to undo the effects of the completed activities but also possibly costs that are encountered when choosing an alternate path through the business process.

The costs that are encountered can be classified according to their usage: Internal or IT costs and external or business costs. Internal or IT costs arise from the IT infrastructure executing the activities of the process model. Examples of IT costs are consumed CPU cycles, used disc or database space, or consumption of networking resources. External or business costs are costs that can be expressed as an amount of money. Business costs are for example cancellation fees that need to be paid if a service has been booked by an activity A and now has to be cancelled because a subsequent activity B has failed.

In particular when a process model has a number of parallel branches of activities that can be executed in many different execution sequences, a particular disastrous situation arises when one of the last activities within the execution sequence fails. In this situation, significant higher processing costs are encountered compared to the situation when one of the first activities in the execution sequence fails.

Costs, in particular failure costs, are just one of the properties of a process; other properties are system throughput, response time, execution time, or total costs. Depending on the optimized process property, an appropriate activity property is being used during optimization beside the failure probability. In the case of the process property failure costs, the appropriate activity properties are costs to execute the activity and the costs to compensate the activity. In the case of the process property execution time, the appropriate activity properties are the execution time to execute the activity and the execution time to compensate the activity.

### SUMMARY OF THE INVENTION

The present invention provides a method of optimization of process properties in the case of a failure of execution of at least one activity of a process model. The process model has a plurality of activities and further has at least a first and a second execution sequence for the execution of the plurality of activities. These execution sequences describe the different orders in which parallel activities can be performed. During execution of the plurality of activities the occurrence of failure is monitored for each activity. Furthermore, properties corresponding to the failure of an activity are also monitored and stored. Finally, an optimization procedure is performed on the basis of the monitored occurrence of failure of each activity and on the basis of the corresponding properties of an activity. The optimization procedure results into selecting a failure optimized execution sequence of the at least first and second execution sequences of the process model. Parallel activities still can be executed in parallel if none of the execution sequences optimizes the process property costs.

In particular, the properties of each activity of the process model may be indicative of failure costs arising due to a failure of the activity. Furthermore, the failure properties being informative of additional failure information, as e.g. failure time, i.e. the time needed for execution of the activity. Other parameters characterizing a failure of an activity are also conceivable and can be applied universally. The inventive method of optimization is therefore adaptable to various optimization parameters, like costs or time, specified by the properties of each activity.

According to a further preferred embodiment of the invention, determining whether an activity is particularly error-prone or reliable makes use of the monitored occurrence of failure of the execution of each of the activities of the process model. Monitoring of occurrence of failure of each activity and monitoring corresponding properties that are associated to the failure of an activity is an efficient means for determining the reliability of each activity. Monitoring also refers to storing of occurred failure and associated failure costs. In this way statistical information about the occurrence of failure of single activities of the process model is gathered and can further be exploited by the optimization procedure in order to determine a failure-optimized execution sequence.

According to a further preferred embodiment of the invention, the at least first and second execution sequences provide alternative ways how to execute the plurality of activities of the process model. These alternative ways preferably refer to a different scheduling of execution of the single activities of the process model. Alternative execution sequences require the existence of at least one fork activity within the process model. Since a plurality of control links emerge from a fork activity pointing to a plurality of different target activities, a corresponding process model exhibits parallel execution paths. Since the control links only constrain that a target activity has to be executed after successful execution of a source activity, the temporal execution order of different activities belonging to different execution paths can be arbitrarily determined by the workflow management system. Generally, each execution sequence describes a distinct temporal execution order of all activities of the process model.

When for example a fork activity has three leaving control links pointing to three different activities, the workflow engine can arbitrarily define the temporal order in which the three target activities are executed. Making use of the inventive optimization method, the workflow management system will decide to serialize parallel activities and to execute the most error-prone activity prior to the more reliable activities, if this optimizes the process property, such as failure costs, according to the defined optimization criteria. Furthermore, the inventive method aims to delay the execution of process property impact intensive, i.e. navigation cost and/or failure cost intensive activities after a successful execution of an error-prone activity. In this way failure costs, for example, can effectively be reduced only by selecting one of alternative execution sequences of the process model.

Even in case when, for example, no specific failure costs arise upon a failure of an activity, the inventive method aims to reduce navigation costs that were due to successful execution of activities before a failure has occurred.

When no execution failure occurs during execution of the process model, each successful execution of the entire process model basically produces the same value for the process property, for example costs. In the case of costs as process property only the navigation costs of each activity accumulate. When in contrast an execution error occurs while executing a distinct activity of the process model, the arising failure costs strongly depend on the number and on the expenses of the activities that have been successfully executed prior to the occurrence of the failure. The failure cost-optimized execution sequence therefore represents one of a plurality of different execution sequences. The failure cost-optimized execution sequence causes minimal failure costs of all possible execution sequences.

According to a further preferred embodiment of the invention, the process property represents the failure costs corresponding to the sum of the costs for the compensation of all activities that have been executed before the failed activity has been invoked and the navigation costs arising from successful execution of process activities prior to occurrence of a failure. When for example a failure occurs at the very end of the execution of a process model, the wasted navigation costs almost equal the costs of the successful execution of the entire process. But since one of the last activities failed, the end activity cannot be carried out successfully and hence these costs arising from successfully executed activities are wasted. Even in case when the failure has not to be repaired explicitly, i.e. no compensation takes place to undo the failure, the failure generates appreciable costs.

According to a further preferred embodiment of the invention, the monitoring of the occurrence of failure of the execution of each of the plurality of activities is performed on the basis of an audit trail. Generally, an audit trail represents some storage mechanism in which all important events in the life of a process or an activity are recorded as an entry. Each entry in the audit trail contains a number of pieces of information, such as date and time when the event takes place, an identifier of the event that uniquely characterizes the event, an identifier of the process for which the event is written, or an identifier of related objects like sub processes or sub activities.

The audit trail logs at least failed and successful execution of each of the plurality of activities and associated cost information. This logging of successful and/or failed execution of activities during execution of the process model provides statistical information about the reliability or error-proneness of each activity and can therefore be extracted from the audit trail. Combining this statistical failure information with properties associated to each activity, such as costs, is therefore essential for determining a process property-optimized execution sequence.

According to a further preferred embodiment of the invention, the monitoring of occurrence of failure as well as the performing of the optimization procedure can both be executed during runtime of the process execution. In this way, the inventive method provides a dynamic approach to process property-optimized execution of a process model. When for example the entire process is started for the first time, no statistical information about failure or reliability of the single activities is initially available. By execution of the single activities, corresponding entries in the audit trail are made being informative about the occurrence of failure as well as the values of associated properties, such as failure costs. Repeated execution of the entire process model associated with logging of activity properties finally results in a permanent improvement of the statistical failure information stored in and provided by the audit trail.

Due to the fact, that the audit trail is permanently updated during execution of the process activities, the optimization procedure can always be performed by making use of the most recent information provided by the audit trail.

According to a further preferred embodiment of the invention, the statistical failure information, i.e. the occurrence of failure, of a distinct activity or a plurality of activities can be provided by a user or by a process modeler having knowledge of the error-proneness of these particular activities. This is especially advantageous if the audit trail does not yet provide any statistical information, when e.g. the process model is executed for the first time.

According to a further preferred embodiment of the invention, the activity properties information, such as failure costs, associated to the failure of a distinct activity can also be provided by a user or by a process modeler prior to execution of the process model. Hence, the statistical failure information as well as the associated activity property information can either be obtained from an audit trail or can be specified by any kind of user input.

For performing of the optimization procedure, statistical failure information and associated activity property information must be accessible for each activity of the process model, irrespectively whether the information has been extracted from an audit trail or has been provided by a user input. For example, a first subset of activities of the process model can be provided with failure information from a user input whereas a second subset of activities of the process model can be provided with failure information extracted from the audit trail.

According to a further preferred embodiment of the invention, the optimization procedure based on the statistical information provided by the audit trail is performed with respect to a plurality of different optimization criteria. These different optimization criteria focus on different aspects of optimization of the entire business process. Generally, a variety of different optimization criteria can be applied in order to optimize execution of the process model with respect to different parameters.

The minimization of failure costs only represents one example of a plurality of different minimization criteria. An other minimization criteria is for example the minimization of the processing time. The overall processing time of the process model depends on the processing time of the single activities as well as on the particular execution sequence. Here, it is also advantageous to schedule error-prone activities as early as possible.

Other optimization criteria focus on a minimization of the response time or on the maximization of the system throughput. Since the optimization procedure causes at least internal navigation costs itself, a particular optimization criteria focusing on the minimization of corresponding compensation costs is also conceivable. All these optimization criteria and their optimization parameters are generally not mutually correlated for a given activity. Hence, applying various optimization procedures focusing on different optimization criteria, may lead to a multitude of different optimized execution sequences of the same process model.

According to a further preferred embodiment of the invention, the different optimization criteria have a different impact on the optimization procedure performed on the basis of the statistical information provided by the audit trail. The optimization procedure can be performed with respect to any one of the above mentioned optimization criteria or with respect to a plurality of various optimization criteria. In such a case, the impact of each optimization criteria on the optimization procedure can universally be determined by e.g. a system administrator, a process modeler or a user of the workflow management system.

Determination of each optimization criteria's impact, thus the weighting of each optimization criteria, can in principle also be determined by arbitrary data processing means such as e.g. data mining. Making use of data mining techniques allows to extract further information of the structure of the process model and e.g. eventual dependencies between several activities. The knowledge of this additional information can then be exploited in order to enhance an optimization procedure by e.g. modifying the impact of different optimization criteria.

According to a further preferred embodiment of the invention, the optimization procedure also accounts for a dynamically changing impact of the plurality of optimization criteria. In this way, the weighting of the different optimization criteria of the optimization procedure can be modified during runtime. Hence execution of the entire process can rapidly be adjusted to modified external conditions. The execution of the entire business process can therefore easily be shifted towards varying constraints without the need of changing the process model itself.

In another aspect, the invention provides a data processing system for optimizing failure costs caused by at least one failing activity of a process model. The process model has a plurality of activities and has further at least a first and a second execution sequence for the execution of the plurality of activities.

The data processing system comprising means for performing an optimization procedure on the basis of a monitored occurrence of failure of each activity and on the basis of the corresponding activity properties of an activity. The optimization procedure results into selecting a process property-optimized execution sequence of the at least first and second execution sequences of the process model.

In still another aspect, the invention provides a computer program product for optimizing a process property of workflow with at least one failing activity of a process model. The process model has a plurality of activities and has further at least a first and a second execution sequence for the execution of the plurality of activities.

The computer program product comprising computer program means being adapted to perform an optimization procedure on the basis of a monitored occurrence of failure of each activity and on the basis of the corresponding activity property of an activity. The optimization procedure results into selecting a process property-optimized execution sequence of the at least first and second execution sequences of the process model.

### BRIEF DESCRIPTION OF THE DRAWINGS

In the following, preferred embodiments of the invention will be described in greater detail by making reference to the drawings in which:

FIG. 1 shows the structure of a simple process model and associated execution sequence and a monitoring table,

FIG. 2 shows the structure of an elaborate process model,

FIG. 3 is illustrative of a flowchart of the optimization procedure,

FIG. 4 illustrates a block diagram of a data processing system for performing the process property optimization procedure.

### DETAILED DESCRIPTION

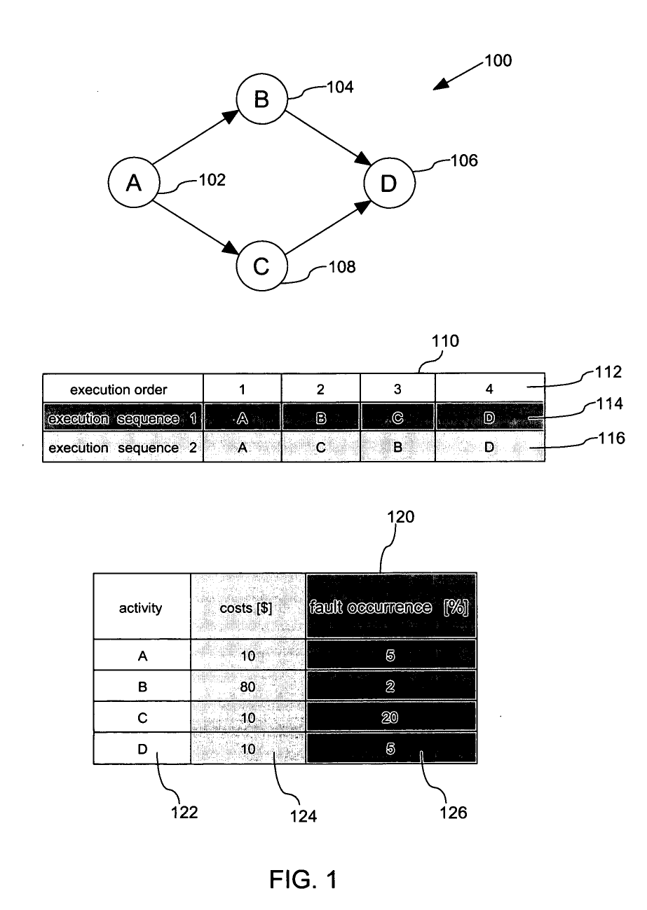

FIG. 1 illustrates the structure of a process model 100 having four process activities 102, 104, 106, 108. Additionally, the single process activities are labeled with A, B, D, C. Process activity A, 102 is the start activity of the process model and further represents a fork activity. The process activity A, 102 therefore has two emerging control links pointing to the process activity B, 104 and to the process activity C, 108. The end activity D, 106 is at the same time a join activity, i.e. it is the target activity of the two control links emerging from activity B, 104 and activity C, 108.

The execution table 110 features three rows of execution order 112, execution sequence 114 and execution sequence 116. The execution order indicates the chronology of execution of the single activities 102, 104, 106, 108. The execution sequence 1, 114 specifies a temporal execution order of the single activities. The execution sequence 1, 114 specifies that after execution of the first activity A, 102, execution of activity B, 104 follows and thereafter execution of activity C, 108 is processed before the end activity D, 106 is processed.

The execution sequence 2, 116 in contrast provides an alternative way of executing the single activities of the process model 100. Referring to execution sequence 2, 116, the execution order of activities B and C has been interchanged. Here execution of the start activity A is followed by execution of activity C, 108, which is followed by the execution of activity B, 104, before the end activity D, 106 is performed.

The monitoring table 120 lists the properties of each single activity of the process model. It can be considered as a condensed form of an audit trail associated with cost information or a list that identifies the properties of the different activities of a process model. In the illustrated embodiment optimization is for the process property failure costs. Thus the monitoring table 120 has three separate columns, an activity column 122, a costs column 124 and a fault column 126. The activity column 122 lists the single activities A, B, C, D of the process model 100, the cost column 124 represents failure costs associated to each of the activities of the activity column 122 and the fault column 126 represents the fault occurrence of each of the activities of the activity column 122. In the example illustrated here, the fault occurrence is given in percent of the number of execution of each activity 102, 104, 106, 108.

Regarding the numbers given in the monitoring table 120, activity B causes costs of $80, whereas activity C only causes costs of $10. This simplified example is restricted to navigation costs in case that one of the activities fails upon execution. Additional failure costs arising due to a necessary compensation of a failed activity are not explicitly described here, but can be treated correspondingly.

The fault column 126 specifies that the activity B 104 has a fault occurrence of 2% whereas the activity C has a fault occurrence of 20%. Given the case that activity C 108 is failing when executed, which is more likely to occur than a failure of activity B 104, it is obvious that in case of a failure execution of the process model along execution sequence 114 produces appreciably higher costs than execution of the process model along execution sequence 116.

Since the activity B 104 is rather expensive and the activity C 108 is relatively error-prone it is advantageous to execute activity C 108 prior to execution of activity B 104. Following the execution sequence 2, 116, only the navigation costs of activity A, 102 and C, 108 are wasted when a relatively frequent failure of activity C occurs. Navigation costs increase by the costs of execution of activity B, 104, when the process model is executed along execution sequence 114. In this case, a failure of activity C produces corresponding appreciably higher wasted costs, without leading to a successful execution of the entire process model.

The monitoring table providing essential information for the optimization procedure can be created in different ways. Preferably, the values of the fault column 126 are extracted from the audit trail, and the values for the cost column 124 are either provided by a user or process modeler. The values for the cost column 124 and the fault column 126 may also be generated by the workflow management system upon execution of the process model. In each case, the process model has to be executed at least once in order to obtain the required statistical information.

Alternatively, the values for the fault column can be manually manipulated or instantiated by a user or process modeler. When for example the error-proneness of a particular activity is known, the corresponding fault column entry can be made prior to the first execution of this particular activity. In this way, the workflow management system is provided with useful initial information of the failure probability of certain activities. The statistical information is supplied by a user or process modeler instead of being extracted from several executions of the process model. Hence, it can effectively prevented, that the process model is initially executed without any statistical information that would inevitably lead to suboptimal execution sequences of the process model. It is clear that such suboptimal execution sequences are associated with appreciable failure costs. When the statistical information is merely extracted from multiple executions of the process model, the establishing of a fault occurrence list may already become rather costly. In contrast, exploiting initial knowledge of failure occurrence of particular activities is an effective means to reduce such avoidable costs.

In a case when no failure occurs, i.e. the entire process model is executed successfully, the navigation costs of each activity simply accumulate and the navigation costs of alternative execution sequences are generally all equal.

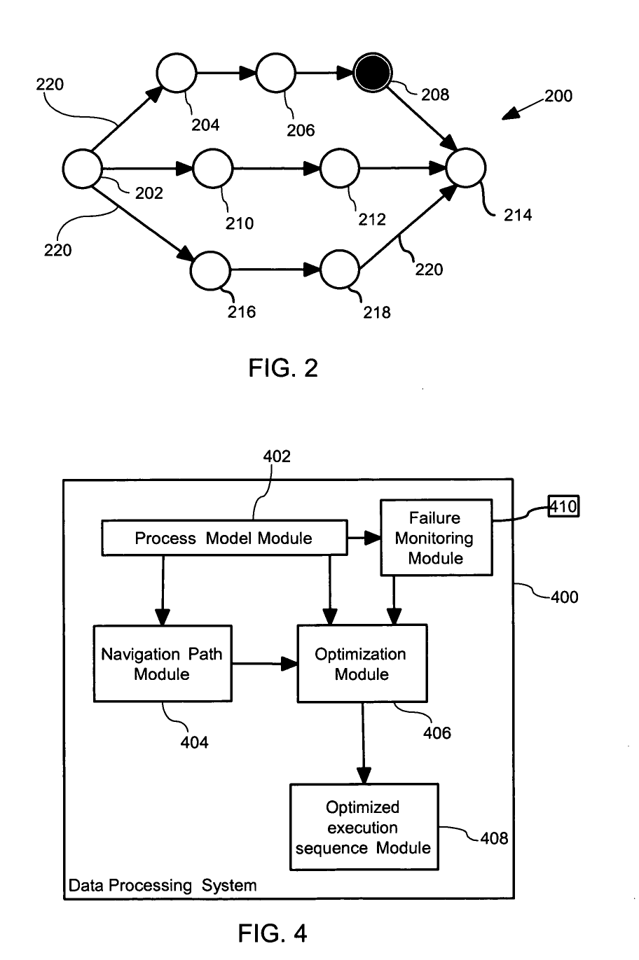

FIG. 2 illustrates a more elaborate structure of a process model 200. Here, the process model 200 has nine different activities 202, 204, . . . 218 featuring three different execution branches. The start activity 202 is a fork activity with three different control links 220 representing the start of three parallel execution path. The end activity 214 is a join activity serving as a synchronization point for the three parallel execution paths. The first execution path has three different activities 204, 206, 208, the second execution path has two activities 210 and 212 and the third execution path has also two activities 216 and 218. The activity 208 is relatively error-prone whereas all other activities of the process model 200 never produce any failure upon execution.

In the example illustrated in FIG. 2, a multitude of different execution sequences is conceivable. Applying a “breath first” execution paradigm, a first execution sequence features a temporal order of activity execution according to: 202-204-210-216-206-212-218-208-214. In this case the error-prone activity is executed as eighth activity of all nine activities. It is obvious, that this first execution sequence causes appreciable failure costs when the activity 208 fails.

An alternative second execution sequence can be defined by applying the “depth first” execution paradigm. In this case the temporal order of execution of the activities has the following form: 202-204-206-208-210-212-216-218-214. Following this second execution sequence, the error-prone activity 208 is executed as the fourth of the nine activities of the process model. In case of failure of the activity 208 only the activities 202, 204 and 206 caused navigation costs and their execution has eventually to be undone causing additional failure costs. It is clear that execution of the process model following the second execution sequence minimizes failure costs compared to an execution following the first execution sequence.

The two different execution sequences only refer to a different scheduling of execution of the single activities of the process model but leave the process model itself unaffected. Hence the control links 220 between the single activities of the process model 200 remain fixed. In this way a failure cost-optimization of a business process can be realized without modification of the process model. The inventive method selects a cost-optimized execution sequence of a plurality of available execution sequences of the process model.

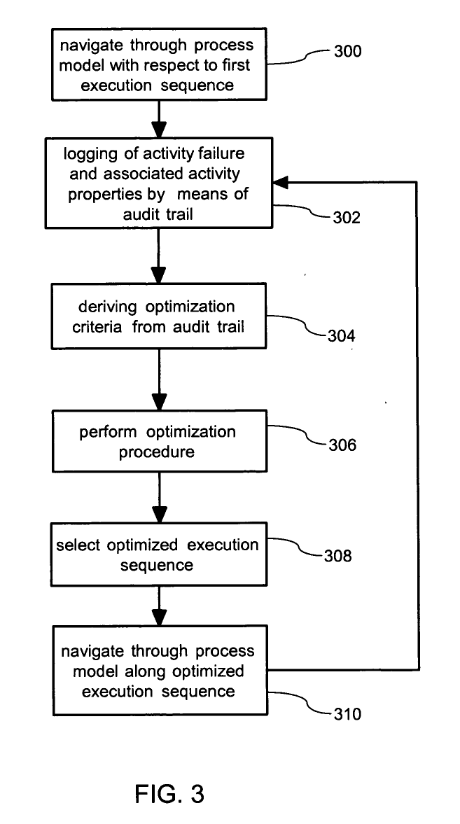

FIG. 3 illustrates a flowchart for performing the optimization procedure of the present invention. In the first step 300 the process model is executed with respect to a first execution sequence. This first execution sequence can be defined or specified by e.g. a user, a process modeler or system administrator having knowledge of the reliability of the single activities or it can be determined by the workflow management system in an arbitrary way. During this first execution of the process model, in step 302 failure or successful execution of each activities and associated failure costs are logged and stored by means of an audit trail. In this way step 302 gathers statistical information of failure occurrence of the single activities.

In the next step 304 various optimization criteria are derived from the audit trail. The optimization criteria can also be provided by e.g. a user, a process modeler or system administrator or can be implemented by any other means into the optimization procedure. Furthermore in step 304, the impact of the different optimization criteria, hence the weighting of the optimization criteria to the optimization procedure can be modified in a plurality of different ways. When the optimization criteria have been derived and further specified in step 304, in the succeeding step 306 the optimization procedure is finally performed. Performing of the optimization procedure in step 306 results in a process property-optimized execution sequence.

Thereafter in step 308 this process property-optimized execution sequence is selected by the workflow engine in order to execute the next instance of the process model along this selected execution sequence. The execution of the process model along the selected and process property-optimized execution sequence is performed in step 310. This execution can be considered as a repeated execution through the process model. Therefore during execution of the process model performed in step 310, the method returns to step 302, where occurrence of failure of single activities of the process model are repeatedly logged by making use of the audit trail. The optimization procedure as illustrated in the steps 300 through 310 can either be performed as a permanent procedure during execution of the process model or can alternatively be performed in a separate way, e.g. after execution of the process model and hence after logging of failure occurrence stored by the audit trail.

FIG. 4 shows a block diagram of a data processing system 400 for performing the inventive process property optimization procedure. The data processing system 400 has a process model module 402, an execution sequence module 404, an optimization module 404, an optimized execution sequence module 408 and a failure monitoring module 410.

The process model module 402 provides the structure of the process model, i.e. the single activities of the process model and associated control links. Furthermore, the process model module 402 provides the properties associated to each activity of the process model.

Based on the information provided by the process model module 402, the execution sequence module 404 calculates a plurality of potential execution sequences that can be navigated when the process model is subject to execution. Irrespectively of selected optimization criteria, the execution sequence module 404 strictly determines all execution sequences that are allowed with respect to the process model.

The failure monitoring module 410 gathers statistical information of occurrence of failure of each activity of the process model during execution of the process model. This statistical information is further used in order to specify the error-proneness of an activity of the process model. The gathered statistical information is then provided to the optimization module 406.

Once a plurality of different execution sequences has been determined by the execution sequence module, the optimization module 406 determines a process property-optimized execution sequence by making use of the plurality of execution sequences provided by the execution sequence module 404 and the associated activity properties provided by the process model module 402. Furthermore the optimization module makes use of the statistical information of occurrence of failure provided by the failure monitoring module 410.

In order to determine a process property-optimized execution sequence, the optimization module 406 makes use of the different optimization criteria, statistical failure information of single process activities and associated activity properties.

Finally, the optimized execution sequence determined by the optimization module 406 is stored in the optimized execution sequence module 408. During execution of the process model with respect to the optimized execution sequence, the workflow engine extracts the necessary execution information from the optimized execution sequence module in order to execute the process model along the optimized execution sequence.

### LIST OF REFERENCE NUMERALS

100 Process Model
102 Activity
104 Activity
106 Activity
108 Activity
110 Execution Table
112 Execution Order
114 Execution Sequence
116 Execution Sequence
120 Monitoring Table
122 Activity Column
124 Cost Column
126 Fault Column
200 Process Model
202 Activity
204 Activity
206 Activity
208 Activity
210 Activity
212 Activity
214 Activity
216 Activity
218 Activity
220 Control Link
400 Data Processing System
402 Process Model Module
404 Execution Sequence Module
406 Optimization Module
408 Optimized Execution Sequence Module
410 Failure Monitoring Module

1. A method of optimization of a process property for a process model having at least one failing activity, the process model having a plurality of activities and having further at least a first and a second execution sequence for the execution of the plurality of activities, the method of optimization of the process property comprising the steps of:
performing an optimization procedure on the basis of an occurrence of failure of each activity of the plurality of activities and corresponding activity properties(,); and
selecting a process property optimized execution sequence of the at least first and second execution sequences.

2. The method according to claim 1, wherein the at least first and second execution sequences provide alternative ways to execute the plurality of activities of the process model, the at least first and second execution sequences provide different scheduling of the plurality of activities of the process model.

3. The method according to claims 1, wherein the occurrence of failure of the execution of at least one activity of the plurality of activities is provided by an audit trail logging at least failed and successful execution of each of the plurality of activities.

4. The method according to claims 1, wherein the properties of at least one activity of the plurality of activities are provided by a user or by a process modeler entering the activity properties of the at least one activity.

5. The method according to claim 1, wherein the occurrence of failure of the execution of at least one activity of the plurality of activities is provided by a user or by a process modeler entering the occurrence of failure of the at least one activity of the plurality of activities.

6. The method according to claims 1, wherein the occurrence of failure of the execution of at least one activity of the plurality of activities is provided by a user or by a process modeler entering the occurrence of failure of the at least one activity of the plurality of activities and wherein the corresponding activity properties are provided by an audit trail logging at least the failure properties corresponding to a failure of each of the plurality of activities.

7. The method according to claim 1, wherein the process property represents failure costs and the activity properties represent costs for executing and compensating the activity, the failure costs representing the sum of the costs of all activities that have to be executed in order to compensate the at least one failing activity and to compensate all activities requiring a compensation that have been executed before the at least one failing activity has been invoked.

8. The method according to claim 1, wherein the process property represents total execution time and the activity properties represent execution time for executing the activity and compensating the activity, the total execution time representing the sum of the execution time for all activities that have to be executed in order to compensate the at least one failing activity and to compensate all activities requiring a compensation that have been executed before the at least one failing activity has been invoked.

9. The method according to claim 1, wherein the process property represents total costs and the activity properties represent the costs for executing and compensating the activity, the total costs representing the sum of the costs for the individual activities, the costs for compensating the at least one failing activity, and the costs for compensating activities requiring a compensation that have been executed before the failing activity has been invoked.

10. The method according to claim 1, wherein the optimization procedure is performed with respect to a plurality of different process and activity properties criteria.

11. The method according to claim 10, wherein the optimization procedure accounts for a dynamically changing impact of the plurality of different process and activity properties criteria.

12. The method according to claim 10, wherein modification of the impact of the plurality of process and activity properties criteria is performed on the basis of a data mining procedure.

13. A data processing system for optimizing of a process property for a process model having a plurality of activities and having further at least a first and a second execution sequence for the execution of the plurality of activities, the data processing system for optimizing of the process property comprising:
means for performing an optimization procedure on the basis of an occurrence of failure of each activity of the plurality of activities and corresponding failure properties(,); and
means for selecting a process property optimized execution sequence of the at least first and second execution sequences.

14. The data processing system according to claim 13, further comprising means for providing an occurrence of failure of the execution of at least one of the plurality of activities by making use of an audit trail logging at least failed and successful execution of each of the plurality of activities.

15. The data processing system according to claim 13 further comprising means for enabling a user or a process modeler to enter the failure properties corresponding to at least one activity of the plurality of activities.

16. The data processing system according to claims 13, further comprising means for enabling a user or a process modeler to enter the occurrence of failure of at least one activity of the plurality of activities.

17. The data processing system according to claims 13, wherein the means for performing the optimization procedure are adapted to account for a plurality of different process and activity properties criteria having different impact on the optimization procedure, the means for performing the optimization procedure being further adapted to account for a dynamically changing impact of the plurality of process and activity properties criteria, the impact of the plurality of process and activity properties criteria being modifiable on the basis of a data mining procedure.

18. A computer program product for optimizing of a process activity for a process model having at least one failing activity, the process model having a plurality of activities and having further at least a first and a second execution sequence for the execution of the plurality of activities, the computer program product comprising computer program means being adapted to perform the steps of:
performing an optimization procedure on the basis of an occurrence of failure of each activity of the plurality of activities and corresponding failure properties(,); and
selecting a process property optimized execution sequence of the at least first and second execution sequences.

19. The computer program product according to claim 18, further comprising computer program means being adapted to make use of an audit trail logging at least failed and successful execution of each of the plurality of activities for providing an occurrence of failure of the execution of at least one of the plurality of activities.

20. The computer program product according to claim 18, wherein the computer program means for performing the optimization procedure are adapted to account for a plurality of different process and activity properties criteria having different impact on the optimization procedure, the means for performing the optimization procedure being further adapted to account for a dynamically changing impact of the plurality of process and activity properties criteria, the impact of the plurality of process and activity properties criteria being modifiable on the basis of a data mining procedure.
